(19) United States
(12) Patent Application Publication
(10) Pub. No.: US 2022/0278399 A1
(43) Pub. Date: Sep. 1, 2022

(54) POUCH CELL AND POUCH CELL PRODUCTION METHOD

(71) Applicant: HONDA MOTOR CO., LTD., Tokyo (JP)

(72) Inventors: Masahiro Ohta, Wako-shi (JP); Takuya Taniuchi, Wako-shi (JP)

(21) Appl. No.: 17/577,470

(22) Filed: Jan. 18, 2022

(30) Foreign Application Priority Data
Feb. 26, 2021 (JP) 2021-030657

(51) Int. Cl. H01M 50/184; H01M 50/105

(52) U.S. Cl. CPC H01M 50/184; H01M 50/105; H01M 10/0413

(57) ABSTRACT

A pouch cell includes: a storage discharge element; and an exterior film that packages the storage discharge element, wherein the storage discharge element includes a corner part, the exterior film includes a bend part that is bent to face the corner part, and a recess groove part that is spaced from the corner part is formed on the bend part at a position that faces the corner part along the corner part.

### CROSS-REFERENCE TO RELATED APPLICATION

Priority is claimed on Japanese Patent Application No. 2021-030657, filed on Feb. 26, 2021, the contents of which are incorporated herein by reference.

### BACKGROUND

### Field of the Invention

The present invention relates to a pouch cell such as a battery and a pouch cell production method.

### Background

In recent years, demands for a high-capacity and high-output battery have rapidly expanded due to the popularization of various large and small electrical and electronic apparatuses such as an automobile, a personal computer, and a mobile phone. Examples of such a battery include a liquid-system battery cell in which an organic electrolysis solution is used as an electrolyte between a positive electrode and a negative electrode, a solid-state battery cell in which a flame retardant solid electrolyte in a solid state is used instead of the electrolyte of the organic electrolysis solution, and the like.

As a solid-state battery, a laminated cell-type pouch cell is known in which a cell having a cuboid shape is wrapped by a laminated film and sealed in a plate shape. By wrapping the cell with an exterior body (film), moisture and air are prevented from entering the battery.

For example, Japanese Unexamined Patent Application, First Publication No. 2020-13637 discloses a pouch cell in which such a film is wrapped around a battery main body and packages the battery main body.

When a battery is used as an on-vehicle electric power source, a vibration input is applied to the battery. At this time, by the storage discharge element vibrating inside the exterior body, rubbing between the storage discharge element and the exterior body may occur, and the exterior body may wear and deteriorate. When the mass of the storage discharge element is large, since a restraining force required for protecting an electrode interface of the cell is large, it is desirable that a surface of an exterior film not have a step. Specifically, it is necessary to consider the impact of rubbing that occurs between a corner part of the storage discharge element and the exterior body.

Japanese Unexamined Patent Application, First Publication No. 2020-13637 discloses that by arranging a buffer member on a corner part of the storage discharge element in the battery, rubbing that occurs between an end part of a laminate body and the exterior body is prevented, and deterioration of a battery exterior by a vibration input is prevented.

### SUMMARY

However, in the technique of Japanese Unexamined Patent Application, First Publication No. 2020-13637, there is a problem in that by arranging a buffer member, a part that protrudes outward is rubbed, and prevention of the deterioration of the exterior body is not sufficient.

An aspect of the present invention provides a pouch cell that is capable of preventing breakage at a corner part of a storage discharge element from occurring without providing a buffer member.

A pouch cell according to a first aspect of the present invention includes: a storage discharge element; and an exterior film that packages the storage discharge element, wherein the storage discharge element includes a corner part, the exterior film includes a bend part that is bent to face the corner part, and a recess groove part that is spaced from the corner part is formed on the bend part at a position that faces the corner part along the corner part.

A second aspect is the pouch cell according to the first aspect, wherein the recess groove part may include: an opening-side groove portion in which surfaces that face each other at an opening side close to the corner part are spaced from each other; and a rear-side groove portion in which surfaces that face each other at a rear side spaced from the corner part are in contact with each other.

A pouch cell production method according to a third aspect of the present invention is a production method of a pouch cell that includes: a storage discharge element having a corner part; and an exterior film that packages the storage discharge element, the method including: a groove formation process in which a recess groove is formed along the corner part on a bend part that is bent along the corner part in the exterior film; and a package process in which the bend part is bent along the corner part and the storage discharge element is packaged by the exterior film, wherein in the package process, by bending the bend part, a recess groove part that is spaced from the corner part is formed at a position that faces the corner part along the corner part by the recess groove.

A fourth aspect is the pouch cell production method according to the third aspect, wherein in the groove formation process, the recess groove may be formed to include: an opening-side inclination portion that is inclined by a first angle in a thickness direction of the exterior film; and a rear-side inclination portion that is inclined by a second angle, and in the package process, by bending the bend part, the groove recess part may be formed which includes: by the opening-side inclination portion, an opening-side groove portion in which surfaces that face each other at an opening side close to the corner part are spaced from each other; and by the rear-side inclination portion, a rear-side groove portion in which surfaces that face each other at a rear side spaced from the corner part are in contact with each other.

A fifth aspect is the pouch cell production method according to the fourth aspect, wherein in the groove formation process, the opening-side inclination portion may be formed after forming the rear-side inclination portion on the exterior film.

According to the first aspect, the recess groove part is formed at an outer position that faces the corner part, and thereby, the corner part of the storage discharge element and the exterior film are not in contact with each other. Thereby, the recess groove part becomes a relief part, and it is possible to prevent a negative effect from occurring such as the exterior film coming into contact with the corner part of the storage discharge element and the storage discharge element becoming damaged.

Accordingly, when packaging the storage discharge element by the exterior film, even in a case where the exterior film is deformed at the time of vacuum welding, the exterior film and the corner part of the storage discharge element do not interfere with each other.

Further, in each of a case when a holding force is applied at the time of arrangement and fixation of the pouch cell and a case when deformation occurs in the storage discharge element at the time of charging or discharging, the exterior film and the corner part of the storage discharge element do not interfere with each other. Thereby, it is possible to prevent degradation of initial performance in the storage discharge element, and at the same time, it is possible to improve durability.

Here, at the time of packaging and sealing of the storage discharge element by the exterior film, by the formation of the recess groove that becomes the recess groove part corresponding to the storage discharge element being performed by embossing, the recess groove serves as a guide for the bend process of the exterior film, the bend (package) process is facilitated, the size of the exterior film is accurate, and it is possible to easily perform a process that is matched to the outer shape of the storage discharge element.

According to the second embodiment, the opening-side groove portion in the recess part becomes a relief part, the rear-side groove portion responds to the deformation that occurs in the exterior film, and it is possible to prevent deformation in the opening-side groove portion. Thereby, the opening-side groove portion which is the relief part does not collapse. Accordingly, it is possible to prevent the opening-side groove portion which is the relief part from coming into contact with the corner part.

According to the third aspect, only by bending the exterior film on which the recess groove is formed in advance in the package process of the storage discharge element by the exterior film, it is possible to form the recess groove part which is a relief part in which the exterior film does not come into contact with the corner part of the storage discharge element.

At the same time, since the recess groove part serves as a guide for the bend process of the exterior film, it is possible to facilitate the bend (package) process, the size of the bend process in the exterior film is accurate, parts other than the recess groove part can be in close contact with the storage discharge element, a process that is matched to the outer shape of the storage discharge element is easily performed, and it is possible to easily produce a pouch cell having an outer surface that does not include a protrusion part which protrudes outward.

According to the fourth aspect, at the time of bending of the exterior film in the package process, an expansion portion always occurs on the corner part of the exterior film. However, after the opening-side inclination portion and the rear-side inclination portion are formed in advance, and a configuration in which the recess groove has a two-step gradient is obtained, by performing a bend process on the configuration, it is possible to reliably facilitate formation of the relief part for preventing the corner part of the storage discharge element and the exterior film from coming contact with each other since the groove recess part which is the relief part does not collapse even in the exterior film in which distortion occurs at the time of bending.

According to the fifth aspect, after the rear-side inclination portion is formed, by scraping the opening side of the rear-side inclination portion and forming the opening-side inclination portion having a different gradient, it is possible to further accurately form a recess groove shape which becomes the relief part. Thereby, it is possible to respond to the exterior film that expands at the time of the bend process, and the recess groove part does not collapse.

Thereby, it is possible to prevent damage at the corner part of the individual storage discharge element from occurring even when the pouch cell is applied to a solid-state battery or the like which requires a large restraining force. Further, since it is possible to obtain a pouch cell in which the outer surface does not unnecessarily protrude outward, a problem such as local rubbing and breakage does not occur.

### BRIEF DESCRIPTION OF THE DRAWINGS

FIG. 1 is a perspective view showing a pouch cell according to a first embodiment of the present invention.

FIG. 2 is a development view showing an exterior film that forms the pouch cell according to the first embodiment.

FIG. 3 is a schematic cross-sectional view enlarging the vicinity of a corner part in the pouch cell according to the first embodiment.

FIG. 4 is a schematic cross-sectional view enlarging the vicinity of a recess groove formed on an exterior film before a bend process in the pouch cell according to the first embodiment.

FIG. 5 is a process view showing a cover process using the exterior film in the pouch cell according to the first embodiment.

FIG. 6 is a process view showing the cover process using the exterior film in the pouch cell according to the first embodiment.

FIG. 7 is a process view showing the cover process using the exterior film in the pouch cell according to the first embodiment.

FIG. 8 is a schematic cross-sectional view enlarging the vicinity of a corner part in the pouch cell according to a second embodiment of the present invention.

FIG. 9 is a schematic cross-sectional view enlarging the vicinity of a recess groove formed on an exterior film before a bend process in the pouch cell according to the second embodiment.

### DESCRIPTION OF EMBODIMENTS

Hereinafter, a pouch cell according to a first embodiment of the present invention will be described with reference to the drawings. The present invention is not limited to the following embodiments and can be implemented with appropriate modifications within the scope of the present invention.

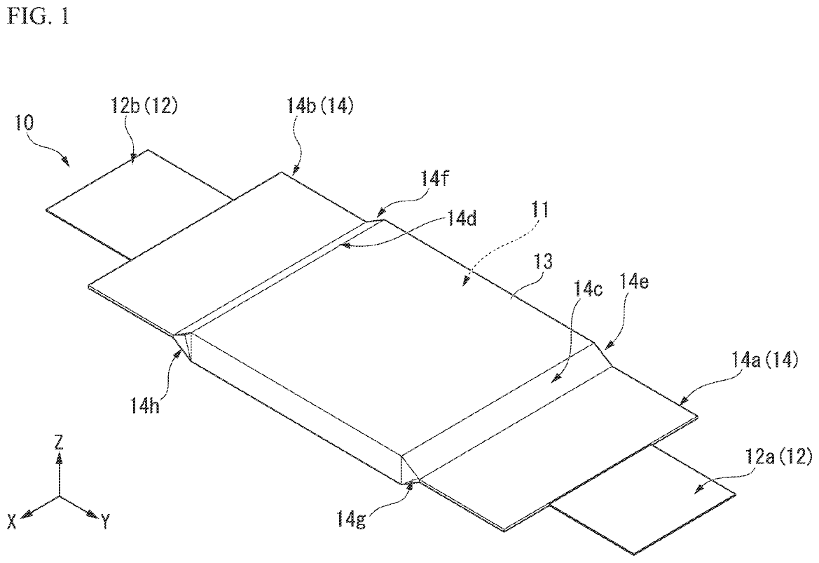

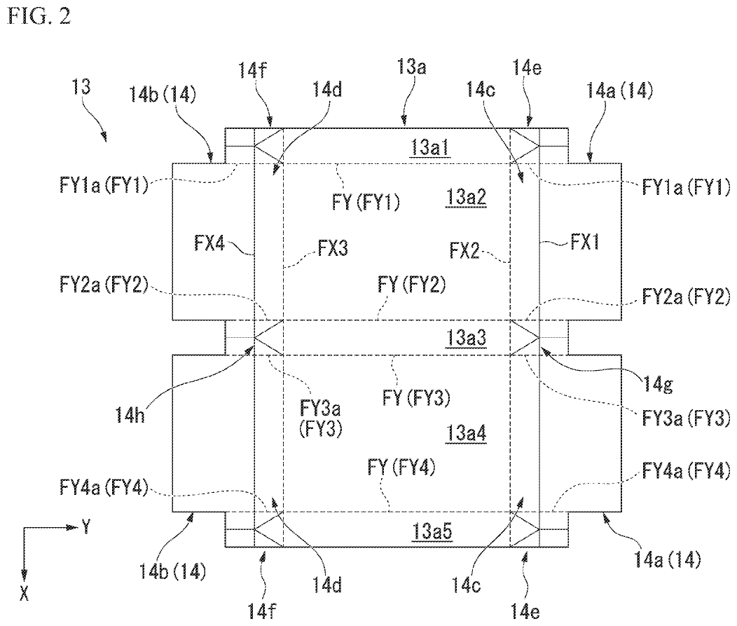

FIG. 1 is a perspective view showing a pouch cell in the present embodiment. FIG. 2 is a development view showing an exterior film of the pouch cell and an airtight holding member in the present embodiment. FIG. 3 is a schematic cross-sectional view enlarging the vicinity of a corner part in the pouch cell of the present embodiment. In the drawing, reference numeral 10 represents a pouch cell.

The pouch cell 10 according to the present embodiment includes a power storage discharge element 11, a power collection tab lead 12, and an exterior film 13 as shown in FIG. 1.

The pouch cell 10 is a battery cell. The battery may be a liquid-system battery cell that uses an organic electrolysis solution as an electrolyte, may be a battery cell that includes a gel-like electrolyte, or may be a solid-state battery cell that includes a flame retardant solid electrolyte as an electrolyte instead of the electrolyte of the organic electrolysis solution. The following embodiment is described using an example of a solid-state battery cell that includes a solid electrolyte as the battery cell.

The storage discharge element 11 is a laminate body in which a positive electrode layer and a negative electrode layer are laminated and a solid electrolyte layer is arranged between the positive electrode layer and the negative electrode layer. The term “laminate” means that enumerated layers are laminated. The term “laminate” can include not only a lamination in which these layers are directly laminated but also an indirect lamination. For example, another layer or the like may be provided between the positive electrode layer and the solid electrolyte layer.

The storage discharge element 11 is covered by the exterior film 13.

The storage discharge element 11 is formed in a substantially cuboid shape. As shown in FIG. 1, the storage discharge element 11 is formed in a plate shape in which a thickness size in a Z-direction is smaller than that in an X-direction and a Y-direction. In the storage discharge element 11, in a Z-direction view, the Y-direction is a longer direction, and the X-direction is a shorter direction. The X-direction, the Y-direction, and the Z-direction are indicated for convenience.

In the storage discharge element 11, a plurality of power collection body tabs extend from an end part in the Y-direction end, and the power collection tab lead 12 that is connected to the power collection body tab is further drawn in the Y-direction.

In the storage discharge element 11, each ridge line in the cuboid shape becomes a corner part 11a. The corner part 11a extends along any of the X-direction, the Y-direction, and the Z-direction. As described later, FIG. 3 shows a cross-section orthogonal to these corner parts 11a.

Two power collection tab leads 12, namely a power collection tab lead 12a and a power collection tab lead 12b, are each drawn from end parts in the Y-direction in the power storage discharge element 11.

The power collection tab lead 12a is drawn from an end part which is on the right side of FIG. 1 in the Y-direction in the storage discharge element 11. The power collection tab lead 12b is drawn from an end part which is on the left side of FIG. 1 in the Y-direction in the storage discharge element 11.

The power collection tab lead 12a and the power collection tab lead 12b are drawn from the power storage discharge element 11 in a direction opposite to each other along the Y-direction. The power collection tab lead 12a and the power collection tab lead 12b extend in the Y-direction. The power collection tab lead 12a and the power collection tab lead 12b are connected to the storage discharge element 11. The end parts of the power collection tab lead 12a and the power collection tab lead 12b on the opposite side of the storage discharge element 11 side are exposed from the exterior film 13. Both the power collection tab lead 12a and the power collection tab lead 12b have a small thickness size in the Z-direction and are formed in a flat plate shape in the XY-direction. Both the power collection tab lead 12a and the power collection tab lead 12b are connected to the vicinity of the middle of the storage discharge element 11 in the X-direction.

Both the power collection tab lead 12a and the power collection tab lead 12b have a smaller thickness size in the Z-direction than a thickness size in the Z-direction of the storage discharge element 11. Both the power collection tab lead 12a and the power collection tab lead 12b have a smaller size in the X-direction than a size in the X-direction of the storage discharge element 11.

Portions of both the power collection tab lead 12a and the power collection tab lead 12b close to the storage discharge element 11 in the Y-direction are covered by the exterior film 13.

The exterior film 13 is wound in a cylindrical shape around the storage discharge element 11 as shown in FIG. 1. Both ends in the Y-direction of the exterior film 13 extend outward to be separated from the storage discharge element 11 and sandwich the power collection tab lead 12a and the power collection tab lead 12b from front and rear surfaces in the Z-direction. The thickness of the exterior film 13 is reduced such that the exterior film 13 is formed in a triangular column shape from the storage discharge element 11 to the power collection tab lead 12a and the power collection tab lead 12b at a boundary where the thickness of a portion that sandwiches the storage discharge element 11 is different from the thickness of a portion that sandwiches the power collection tab lead 12a and the power collection tab lead 12b. In this part having a triangular column shape, a portion of the exterior film 13 that becomes a gusset at both ends in the X-direction is folded inward. The exterior film 13 seals the storage discharge element 11.

As shown in FIG. 2, the exterior film 13 is a pouch film having a sheet shape. The exterior film 13 is wound on the storage discharge element 11 around an axis line in the Y-direction. The exterior film 13 is in close contact with the storage discharge element 11 except for both end parts in the Y-direction.

The exterior film 13 is not particularly limited as long as the exterior film 13 is a film that can house and seal the storage discharge element 11. The exterior film 13 can be preferably a film that can provide airtightness to the pouch cell 10.

The exterior film 13 may include a barrier layer formed of an inorganic thin film or the like such as a metal foil which is, for example, aluminum, nickel, stainless steel, or the like. By including the barrier layer, the exterior film 13 can be provided with airtightness. The exterior film 13 can preferably include a seal layer formed of a flexible resin such as polyethylene resin. The exterior film 13 can be joined by welding laminated seal layers facing each other. Therefore, a process of applying an adhesive agent is not required.

The exterior film 13 may or may not include the seal layer. In this case, the exterior film 13 is joined together by an adhesive agent, and thereby, it is also possible to form the pouch cell 10.

Examples of the exterior film 13 can include a laminate body in which the seal layer described above, the barrier layer described above, and a base material layer constituted of polyethylene terephthalate, polyethylene naphthalate, nylon, polypropylene, and the like are laminated. These layers may be laminated via a conventionally known adhesive agent or may be laminated by an extrusion coating method or the like.

A preferred thickness of the exterior film 13 varies depending on the material. The thickness of the exterior film 13 can be preferably equal to or more than 50 μm and more preferably equal to or more than 100 μm. The thickness of the exterior film 13 can be preferably equal to or less than 700 μm and more preferably equal to or less than 200 μm.

The exterior film 13 may be a single layer film or may be a film in which a plurality of layers are laminated. The exterior film 13 in the present embodiment can be a single film having a sheet shape that houses and seals the storage discharge element 11.

The exterior film 13 is welded to front and rear surfaces in the Z-direction of the power collection tab lead 12a and the power collection tab lead 12b at a position away from the storage discharge element 11 in the Y-direction and at a further outer side in the Y-direction than the storage discharge element 11. The further outer side in the Y-direction of the exterior film 13 than the storage discharge element 11 forms the holding part 14.

As shown in FIG. 1, the holding part 14 includes a holding part 14a that sandwiches the power collection tab lead 12a and a holding part 14b that sandwiches the power collection tab lead 12b.

Both the holding part 14a and the holding part 14b extend in the Y-direction. The holding part 14a and the holding part 14b extend symmetrically from the center of the storage discharge element 11 in the Y-direction. The X-direction sizes of the holding part 14a and the holding part 14b are substantially the same as the X-direction size of the storage discharge element 11.

The power collection tab lead 12a and the power collection tab lead 12b are exposed from end portions that are the outsides in the Y-direction of the holding part 14a and the holding part 14b, respectively.

The power collection tab lead 12a and the power collection tab lead 12b are located at center portions in the X-direction of the holding part 14a and the holding part 14b, respectively. The exterior film 13 is directly bonded together at both end portions in the X-direction of the holding part 14a and the holding part 14b.

The holding part 14a and the holding part 14b have an outline having a substantially rectangular shape in a Z-direction view.

As shown in FIG. 1 and FIG. 2, the exterior film 13 is continuous such that a side closer to the storage discharge element 11 in the Y-direction than the holding part 14a and the holding part 14b becomes large to a Z-direction thickness size of the storage discharge element 11. In the exterior film 13, the side closer to the storage discharge element 11 in the Y-direction than the holding part 14a and the holding part 14b forms a triangular column part 14c and a triangular column part 14d in accordance with an increase of the thickness size from the holding part 14a and the holding part 14b to the storage discharge element 11.

As shown in FIG. 1 and FIG. 2, in the triangular column part 14c and the triangular column part 14d, both end portions in the X-direction are folded inward and form gusset portions 14e to 14h. As shown in FIG. 2, the exterior film 13 on which the gusset portions 14e to 14h are formed extends to the Y-direction outside in a direction that is separated from the storage discharge element 11 while being folded in the Z-direction. The exterior film 13 on which the gusset portions 14e to 14h are formed extends in the Y-direction to the middle of the holding part 14a and the holding part 14b. The Y-direction end portions of the exterior film 13 on which the gusset portions 14e to 14h are formed are sandwiched by the holding part 14a and the holding part 14b.

The exterior film 13 includes a bend part FY that is bent to face the corner part 11a.

The bend part FY corresponds to the corner part 11a among fold lines described later. The bend part FY extends in the Y direction.

A recess groove part F is formed on the bend part FY at a position facing the corner part 11a along the corner part 11a. The recess groove part F and the corner part 11a are separated from each other as shown in FIG. 3. That is, the recess groove part F is formed on an inside of the exterior film 13 such that the corner part 11a and the exterior film 13 do not come into direct contact with each other.

In the pouch cell 10 of the present embodiment, by forming the recess groove part F on the bend part FY of the exterior film 13, even in a case where the storage discharge element 11 is deformed, it is possible to maintain a state in which the exterior film 13 and the corner part 11a of the storage discharge element 11 do not interfere with each other. Alternatively, even in a case where the exterior film 13 is deformed, the exterior film 13 and the corner part 11a of the storage discharge element 11 cannot interfere with each other.

For example, the pouch cell 10 may be clamped and held by a member that constitutes a module. Further, when the pouch cell 10 is mounted on a vehicle, a large holding force is applied to the pouch cell 10, namely, the storage discharge element 11 via the exterior film 13. Furthermore, the storage discharge element 11 may be deformed at the time of charging or discharging. Even in such a case, by the recess groove part F, it is possible to maintain a state in which the exterior film 13 and the corner part 11a of the storage discharge element 11 are not in direct contact with each other, namely, a condition in which the exterior film 13 and the corner part 11a of the storage discharge element 11 do not interfere with each other.

Further, in a production process of the pouch cell 10, when the storage discharge element 11 is packaged by the exterior film 13, even in a case where the exterior film 13 is deformed at the time of vacuum welding, it is possible to maintain a state in which the exterior film 13 and the corner part 11a of the storage discharge element 11 are not in direct contact with each other, namely, a state in which stress does not act on the corner part 11a of the storage discharge element 11 from the exterior film 13. Even in such a case, by the recess groove part F, it is possible to maintain a state in which the exterior film 13 and the corner part 11a of the storage discharge element 11 do not interfere with each other.

Hereinafter, a production method of the pouch cell 10 is described.

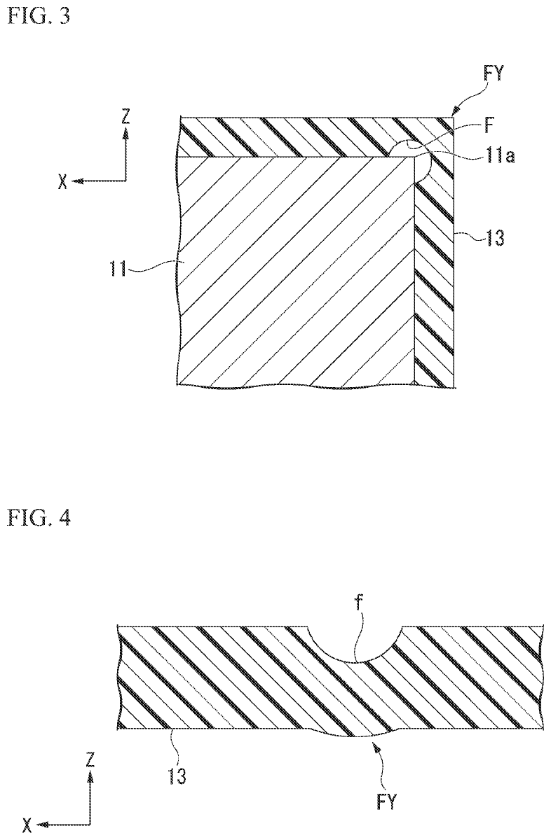

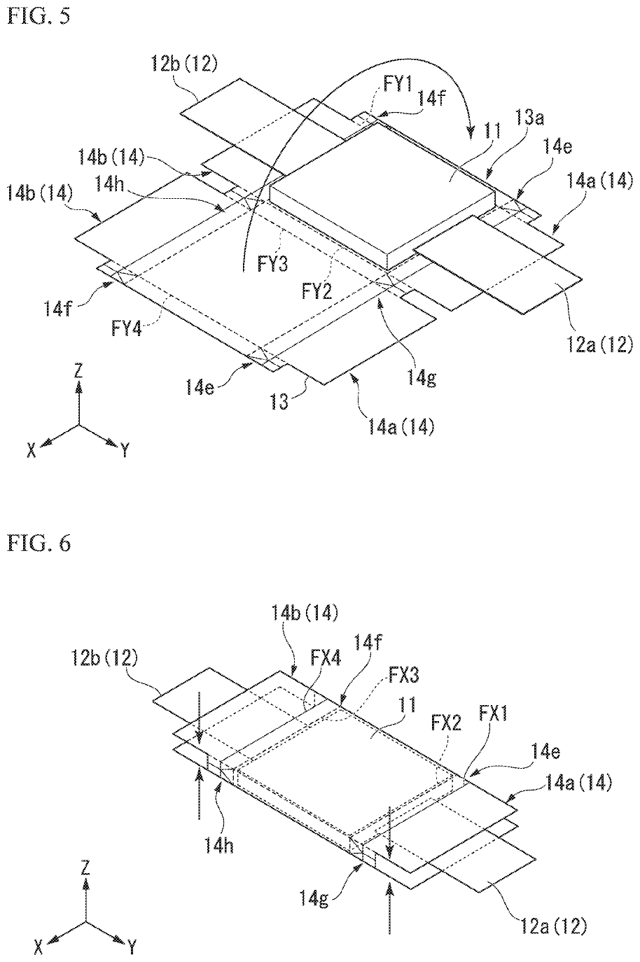

FIG. 4 is a schematic cross-sectional view enlarging the vicinity of a recess groove formed on an exterior film before a bend process in the pouch cell in the present embodiment. FIG. 5 to FIG. 7 are process views showing a cover process using the exterior film of the pouch cell in the present embodiment.

In the present embodiment, the storage discharge element 11 is placed on the exterior film 13 on which a fold line is formed, the exterior film 13 is folded in a cylindrical shape so as to seal the storage discharge element 11, and the pouch cell is formed.

First, as a groove formation process, as shown in FIG. 2, a plurality of parallel fold lines FX1 to FX4 along the X-direction and a plurality of parallel fold lines FY1 to FY4 along the Y-direction are formed on the exterior film 13. Both the fold lines FX1 to FX4 and the fold lines FY1 to FY4 are formed in a straight line. Further, an oblique fold line that is not along the X-direction and the Y-direction is formed on the gusset portion 14e, the gusset portion 14f, the gusset portion 14g, and the gusset portion 14h.

The fold line FX1 is formed at a boundary position between the holding part 14a and the triangular column part 14c. The fold line FX2 is formed at a boundary position between the triangular column part 14c and a central part 13a that encloses the storage discharge element 11. The fold line FX3 is formed at a boundary position between the central part 13a that encloses the storage discharge element 11 and the triangular column part 14d. The fold line FX4 is formed at a boundary position between the triangular column part 14d and the holding part 14b.

The fold line FY1 is formed at a boundary position between the holding part 14a on the front surface side and the gusset portion 14e and at a boundary position between the holding part 14b on the front surface side and the gusset portion 14f. The fold line FY2 is formed at a boundary position between the holding part 14a on the front surface side and the gusset portion 14g and at a boundary position between the holding part 14b on the front surface side and the gusset portion 14h.

The fold line FY3 is formed at a boundary position between the holding part 14a on the rear surface side and the gusset portion 14g and at a boundary position between the holding part 14b on the rear surface side and the gusset portion 14h. The fold line FY4 is formed at a boundary position between the holding part 14a on the rear surface side and the overlapped bonded gusset portion 14e and at a boundary position between the holding part 14b on the rear surface side and the overlapped bonded gusset portion 14f.

The fold line FY1 includes a bend part FY that becomes a position which faces the corner part 11a of the storage discharge element 11 and a fold line FY1a that becomes a portion other than the bend part FY. The bend part FY is a boundary between a middle lateral portion 13a1 that is sandwiched between the gusset portion 14e and the gusset portion 14f and a rear surface portion 13a2 that corresponds to the Z-direction rear surface of the storage discharge element 11. The bend part FY and the fold line FY1a form the same straight line.

The fold line FY1a is constituted of: a part that is a boundary between the gusset portion 14e and the holding part 14a and a boundary between the gusset portion 14e and the triangular column part 14c; and a part that is a boundary between the gusset portion 14f and the holding part 14b and a boundary between the gusset portion 14f and the triangular column part 14d.

The fold line FY2 includes a bend part FY that becomes a position which faces the corner part 11a of the storage discharge element 11 and a fold line FY2a that becomes a portion other than the bend part FY. The bend part FY is a boundary between the rear surface portion 13a2 that corresponds to the Z-direction rear surface of the storage discharge element 11 and a middle lateral portion 13a3 that is sandwiched between the gusset portion 14g and the gusset portion 14h. The bend part FY and the fold line FY2a form the same straight line.

The fold line FY2a is constituted of: a part that is a boundary between the gusset portion 14g and the holding part 14a and a boundary between the gusset portion 14g and the triangular column part 14c; and a part that is a boundary between the gusset portion 14h and the holding part 14b and a boundary between the gusset portion 14h and the triangular column part 14d.

The fold line FY3 includes a bend part FY that becomes a position which faces the corner part 11a of the storage discharge element 11 and a fold line FY3a that becomes a portion other than the bend part FY. The bend part FY is a boundary between a front surface portion 13a4 that corresponds to the Z-direction front surface of the storage discharge element 11 and the middle lateral portion 13a3 that is sandwiched between the gusset portion 14g and the gusset portion 14h. The bend part FY and the fold line FY3a form the same straight line.

The fold line FY3a is constituted of: a part that is a boundary between the gusset portion 14g and the holding part 14a and a boundary between the gusset portion 14g and the triangular column part 14c; and a part that is a boundary between the gusset portion 14h and the holding part 14b and a boundary between the gusset portion 14h and the triangular column part 14d.

The fold line FY4 includes a bend part FY that becomes a position which faces the corner part 11a of the storage discharge element 11 and a fold line FY4a that becomes a portion other than the bend part FY. The bend part FY is a boundary between the front surface portion 13a4 that corresponds to the Z-direction front surface of the storage discharge element 11 and a middle lateral portion 13a5 that is sandwiched between the gusset portion 14e and the gusset portion 14f. The bend part FY and the fold line FY4a form the same straight line.

The fold line FY4a is constituted of: a part that is a boundary between the gusset portion 14e and the holding part 14a and a boundary between the gusset portion 14e and the triangular column part 14c; and a part that is a boundary between the gusset portion 14f and the holding part 14b and a boundary between the gusset portion 14f and the triangular column part 14d.

As shown in FIG. 4, a recess groove f is formed on the bend part FY. Here, as described later, the recess groove f forms the recess groove part F when the exterior film 13 is folded and wound around the storage discharge element 11, and the exterior film 13 and the storage discharge element 11 are welded together. Thereby, the recess groove part F is formed on the exterior film 13 that becomes a position which faces the corner part 11a of the storage discharge element 11 as shown in FIG. 3. A state is maintained in which the corner part 11a and the recess groove part F are separated from each other.

The fold lines FX1 to FY4 are formed on the exterior film 13 by, for example, a method such as mold pressing, drawing, embossing, or scraping by a grinder, blasting, or the like as a groove formation process. The fold lines FX1 to FY4 are formed along the shape and the size of the power collection tab lead 12 and the storage discharge element 11 housed in the exterior film 13.

Further, the fold lines FY1a to FY4a are formed as a guideline in the fold process of the exterior film 13 similarly to the fold lines FX1 to FX4. On the other hand, the recess groove f in the bend part FY is formed as a guideline in the fold process. Further, the recess groove f is a shape that can form the recess groove part F when being folded and enclosing the storage discharge element 11, and the formation process condition of the recess groove f is set.

Specifically, the fold lines FY1 to FY4 that become the recess groove f have a larger width size and a larger depth size than the fold lines FX1 to FX4 and the fold lines FY1a to FY4a.

Accordingly, for example, the fold line FY1a can be formed by embossing or the like similarly to the fold line FX1 or the like as a single straight line at the same time as the fold line FY1, and then a widened recess groove f can be formed by further second embossing or the like. In this case, the fold lines FY2a to FY4a can be also formed by a similar formation process.

Alternatively, the fold lines FY1a to FY4a can be formed by embossing or the like similarly to the fold line FX1 or the like as a different step from the fold lines FY1 to FY4, and the recess groove f can be formed by embossing or the like as the fold lines FY1 to FY4 as another process.

As shown in FIG. 5, the storage discharge element 11 to which the power collection tab lead 12a and the power collection tab lead 12b are connected is placed at the central part 13a on the exterior film 13 on which the fold lines FX1 to FY4a are formed as described above.

Next, as a package process, all of the fold lines FY1 to FY4a that extend in the Y-direction are folded in a valley form as shown by an arrow in FIG. 5. Thereby, as shown in FIG. 6, the exterior film 13 is wound around the storage discharge element 11 so as to surround the circumference of the storage discharge element 11. Then, the gusset portion 14e, the gusset portion 14f, and a part sandwiched between the gusset portion 14e and the gusset portion 14f on the rear side in FIG. 6 are overlapped and welded. Thereby, the exterior film 13 becomes a cylindrical shape.

At this time, the recess groove f is bonded to a position that faces along the corner part 11a of the storage discharge element 11, and both edge portions in the opening of the recess groove f come into contact with each other so as to each be separated from the corner part 11a of the storage discharge element 11 in a direction orthogonal to the Y-direction in which the corner part 11 extends. Further, the vicinity of the middle on the rear side of the recess groove f maintains a position separated from the corner part 11a of the storage discharge element 11 and forms the recess groove part F.

Next, the fold line FX2 and the fold line FX3 that extend in the X-direction are folded in a mountain form, the fold line FX1 and the fold line FX4 that extend in the X-direction are folded in a valley form, and parts that are located at a further outer side than the storage discharge element 11 in the Y-direction and become the holding part 14a and the holding part 14b are caused to be close to, overlap with, and be in contact with each other in the Z-direction as shown by an arrow in FIG. 6. At this time, all of the gusset portions 14e to 14h are folded inward in the X-direction. Then, the portions that become the holding part 14a and the holding part 14b are overlapped and welded together with the power collection tab lead 12a and the power collection tab lead 12b.

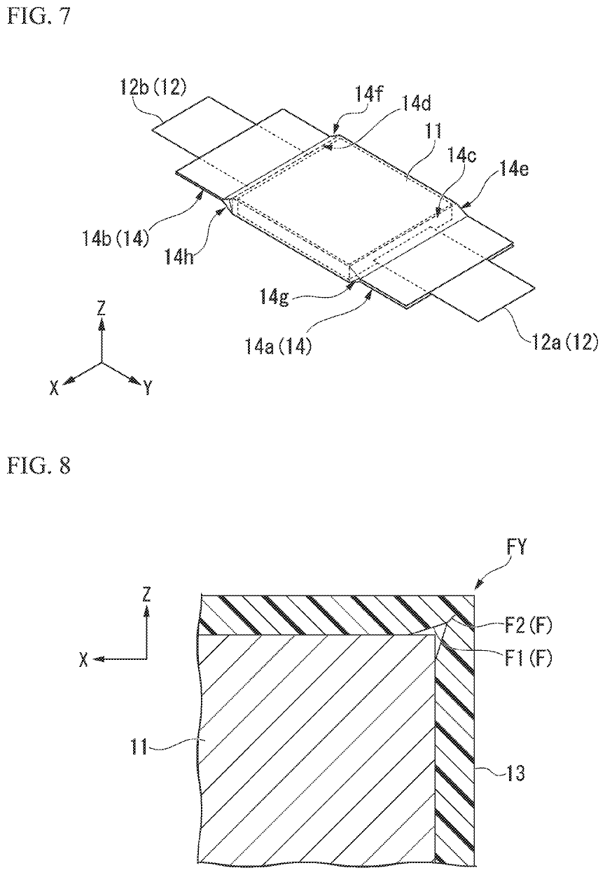

Thereby, as shown in FIG. 7, the triangular column part 14c, the holding part 14a that extends in the Y-direction outside of the triangular column part 14c, the triangular column part 14d, and the holding part 14b that extends in the Y-direction outside of the triangular column part 14d are formed. Thereby, the pouch cell 10 is produced as shown in FIG. 1.

In the present embodiment, by maintaining a state in which the recess groove part F is not in contact with the corner part 11a, it is possible to prevent damage or deformation of the corner part 11a, prevent degradation of initial performance in the storage discharge element 11, and improve durability. Further, in the bend part FY formed on the exterior film 13 before folding, by forming the recess groove f on the inner surface of the exterior film 13 in contact with the outer circumference of the storage discharge element 11 by embossing, it is possible to form the recess groove f that serves as a relief part and at the same time, form the recess groove f that serves as a guide of a process position for the bend process of the exterior film 13. Thereby, by the presence of the recess groove f that serves as the guide of the bend process, it becomes possible to easily perform a bend (package) process, and it is possible to maintain the accuracy of the bend process position and accurately obtain the size of the exterior film 13 in the bend process.

Further, in the present embodiment, even when the recess groove part F is formed, the outer surface of the pouch cell 10 can maintain a state in which the outer surface does not protrude compared to the outer surface in a case where there is not the recess groove part F. Therefore, problems such as this portion rubbing and wearing, and the seal performance by the exterior film 13 becoming degraded or the like do not occur.

In the present embodiment, the bend part FY on which the recess groove part F is formed is arranged on a portion corresponding to the corner part 11a that extends in the Y-direction; however, additionally, a configuration can also be used in which a portion corresponding to the corner part 11a that extends in the X direction has a bend part FX. In this case, the recess groove f can be formed in advance on a portion of fold lines FX2 and FX3 of the bend part FX that faces the corresponding corner part 11a in the X-direction.

Further, in this case, among the recess groove part F formed by folding the exterior film 13, an open end part on the side of the triangular column parts 14c and 14d cannot be in contact with the surface of the storage discharge element 11. This corresponds to the fact that the exterior film 13 on the side of the triangular column parts 14c and 14d is formed in a state of not being in contact with the surface of the storage discharge element 11.

Alternatively, a configuration can also be used which has a bend part FZ on a portion corresponding to the corner part 11a that extends in the Z-direction in addition to the corner part 11a that extends in the Y-direction. In this case, the bend part FZ can be formed on a portion of the fold lines FX2 and FX3 that faces the corresponding corner part 11a in the Z-direction. Further, similarly to the bend part FX, among the recess groove part F, an open end part on the side of the gusset portions 14e to 14h cannot be in contact with the surface of the storage discharge element 11. This corresponds to the fact that the exterior film 13 on the side of the gusset portions 14e to 14h is formed in a state of not being in contact with the surface of the storage discharge element 11.

Hereinafter, a pouch cell according to a second embodiment of the present invention is described with reference to the drawings.

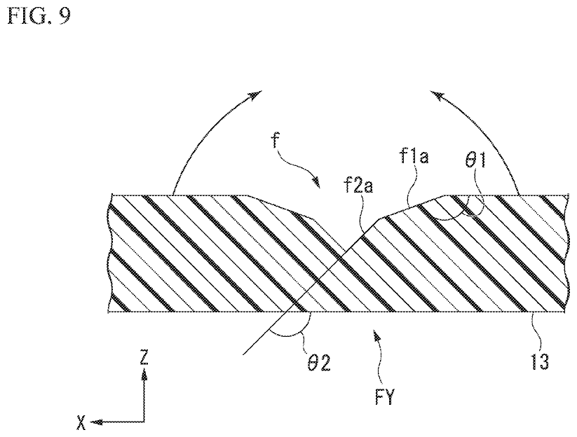

FIG. 8 is a schematic cross-sectional view enlarging the vicinity of a corner part in the pouch cell of the present embodiment. FIG. 9 is a schematic cross-sectional view enlarging the vicinity of a recess groove formed on an exterior film before a bend process in the pouch cell in the present embodiment. Although the present embodiment differs from the first embodiment described above regarding the shape of a recess groove part and the recess groove, the same reference numerals are given to other configurations that correspond to the first embodiment described above, and description thereof is omitted.

In the present embodiment, as shown in FIG. 8, a recess groove part F formed on a bend part FY includes an opening-side groove portion F1 and a rear-side groove portion F2. The opening-side groove portion F1 is located on an opening side of the recess groove part F close to the corner part 11a in the thickness direction of the exterior film 13. In the opening-side groove portion F1, surfaces that face each other and extend along the corner part 11a are separated from each other.

The rear-side groove portion F2 is located on a rear side of the recess groove part F, that is, a side away from the corner part 11a in the thickness direction of the exterior film 13. The rear-side groove portion F2 continues to the opening-side groove portion F1 and extends in a direction away from the corner part 11a. In the rear-side groove portion F2, surfaces that face each other and extend along the corner part 11a are in contact with each other.

The opening-side groove portion F1 is formed such that a distance between the surfaces that face each other is enlarged as the surfaces approach the corner part 11a from the side of the rear-side groove portion F2 in which the surfaces are in contact with each other.

That is, in the rear-side groove portion F2, all of the opposing surfaces are in contact with each other from a farthermost position from the corner part 11a to a position closest to the corner part 11a. Therefore, even when stress acts on the exterior film 13, the contact position between the opposing surfaces that are in contact with each other in the rear-side groove portion F2 is just deformed, and it is possible to prevent the opening-side groove portion F1 from being deformed.

Alternatively, even when stress acts on the exterior film 13, the contact between the opposing surfaces of the rear-side groove portion F2 is maintained at a position closest to the opening-side groove portion F1 in the thickness direction of the exterior film 13. Thereby, it is possible to prevent deformation in the opening-side groove portion F1 from occurring and prevent the exterior film 13 from coming into contact with the corner part 11a.

In order to maintain a state in which the opposing surfaces of the rear-side groove portion F2 are in contact with each other, a shape can be maintained in which, even when stress acts on the exterior film 13, a distance in a direction where the opposing surfaces in the opening-side groove portion F1 are orthogonal to the corner part 11a is enlarged as the surfaces approach the corner part 11a from a corner part 11a side position in the rear-side groove portion F2.

Hereinafter, a production method of the pouch cell 10 in the present embodiment is described.

In the present embodiment, as a groove formation process, as shown in FIG. 9, the recess groove f of the bend part FY is formed on the exterior film 13, for example, by a method such as mold pressing, drawing, embossing, or scraping by a grinder, blasting, or the like. The recess groove f is assumed to be a shape that can form the recess groove part F when being folded and enclosing the storage discharge element 11, and the formation process condition of the recess groove f is set.

The recess groove f includes: an opening-side inclination portion f1a that is inclined by a first angle in the thickness direction of the exterior film 13; and a rear-side inclination portion f2a that is inclined by a second angle.

As shown in FIG. 9, the first angle θ1 in the opening-side inclination portion f1a can be 100 to 150 degrees, and the second angle θ2 in the rear-side inclination portion f2a can be 60 to 100 degrees. That is, the first angle θ1 in the opening-side inclination portion f1a is larger than the second angle θ2 in the rear-side inclination portion f2a.

That is, a two-step gradient is formed for the recess groove f.

Here, the difference between the first angle θ1 and the second angle θ2 can be preferably increased as much as possible. For example, the difference between the first angle θ1 and the second angle θ2 can be equal to or more than 10 degrees and can be preferably 20 to 90 degrees. Further, when the second angle θ2 is too small, the exterior film 13 may be damaged.

In the formation of the recess groove f, first, after forming the rear-side inclination portion f2a, by scraping an edge portion on the opening side in the rear-side inclination portion f2a, it is possible to form the opening-side inclination portion f1a. Specifically, when the recess groove f is formed, first, the rear-side inclination portion f2a is formed by mold pressing. Then, the edge portion on the opening side in the rear-side inclination portion f2a is scraped by a method such as blasting, and the opening-side inclination portion f1a is formed.

By employing such a formation method of the recess groove f, the volume of the exterior film 13 near the recess groove f can be reduced. Thereby, when the exterior film 13 is bent, the expansion of the exterior film 13 to the inside can be further reduced in a direction of an arrow shown in FIG. 9. Thereby, it is possible to improve the effect of the recess groove f as a relief part.

By setting the first angle θ1 and the second angle θ2 in this way, when the bend part FY is bent in the package process, the surfaces of the rear-side inclination portion f2a approach and come into contact with each other, and the exterior film 13 is not further bent.

Alternatively, by setting the first angle θ1 and the second angle θ2 as described above, when the bend part FY is bent in the package process, at least boundary positions of the rear-side inclination portion f2a with the opening-side inclination portion f1a approach and come into contact with each other, and even when positions of the rear-side inclination portion f2a that are separated from the opening-side inclination portion f1a are not in contact with each other, since rearmost positions of the rear-side inclination portion f2a are continuous with each other, the exterior film 13 is not further bent.

In the package process, the bend part FY is bent so as to be folded in a valley form in a direction in which the recess groove f is formed. At this time, as shown by an arrow in FIG. 9, opening ends of the opening-side inclination portion f1a are bent to approach each other around the rearmost portion of the recess groove f.

Then, the surfaces of the rear-side inclination portion f2a approach and come into contact with each other. Thereby, the rear-side groove portion F2 in which the surfaces that face each other are in contact with each other is formed. The exterior film 13 is not further bent. In this state, the opening-side groove portion F1 that is not in contact with the corner part 11a is formed.

In the recess groove part F, positions closest to the corner part 11a of the rear-side groove portion F2 are in contact with each other. That is, since two-step gradients are formed as the recess groove f, and the middles of the gradients are formed to protrude to be close to each other, it is possible to maintain a state in which the recess groove part F that becomes a relief part does not collapse even when stress is generated on the exterior film 13 at the time of bending.

Even in the present embodiment, an advantage similar to that of the embodiment described above can be achieved.

At the time of the bend process of the exterior film, the position corresponding to the corner part 11a is bent and expands outward. Although an expansion portion of the exterior film 13 inevitably occurs, since the recess groove part F does not collapse, it is possible to reliably maintain a state in which the exterior film 13 and the corner part 11a are separated from each other.

In the present embodiment, as shown in FIG. 9, which is a cross-sectional view, a cross-sectional outline of each of the opening-side inclination portion f1a and the rear-side inclination portion f2a of the recess groove f is shown as a straight line; however, the embodiment is not limited to this configuration. For example, in the opening side inclination portion f1a, the cross-sectional outline can be a curved surface as in the first embodiment shown in FIG. 4.

In particular, from the boundary position with the rear-side inclination portion f2a toward the opening side of the recess groove f, the cross-sectional outline of the opening-side inclination portion f1a can be recessed, that is, the volume of the exterior film 13 at the opening-side inclination portion f1a in the recess groove f can be preferably reduced. In the rear-side inclination portion f2a, the boundary positions between the rear-side inclination portion f2a and the opening-side inclination portion f1a may be in contact with each other at the time of the bend process of the exterior film, and the cross-sectional outline of the rear-side inclination portion f2a is not limited.

Alternatively, a configuration can also be used in which the surfaces of the rear-side inclination portion f2a are not in contact with each other except for a boundary portion with the opening-side inclination portion f1a and a position that is farthest from the corner part 11a in a direction separated from the corner part 11a in the thickness direction of the exterior film 13. Even in this case, the configuration can preferably include an inclination surface in which surfaces that face each other protrude to be closest to each other at a position closest to the corner part 11a in the rear-side inclination portion f2a.

In the present embodiment, in the formation of the recess groove f, after forming the opening-side inclination portion f1a by first embossing or the like, the rear-side inclination portion f2a can be further formed by second embossing or the like.

In this case, in the first embossing, a press mold corresponding to the first angle θ1 or a roller or the like can be used, and in the second embossing, a press mold corresponding to the second angle θ2 or a roller or the like can be used.

Alternatively, a recess groove f having a two-step gradient can also be formed by a single process using a roller formed in a step shape in which the outer circumference has a blade thickness direction cross-sectional angle corresponding to the second angle θ2 and the center side has a blade thickness direction cross-sectional angle corresponding to the first angle θ1.

Further, the present invention can employ a configuration in which the configurations in the embodiments described above are individually combined or a particular configuration is removed.

As an application example of the present invention, the present invention can be used for the exterior of a brittle solid body. Examples of the brittle solid body include a (brittle) confectionery or the like. Further, the present invention can be applied to an exterior body at the time of transportation of an electrode laminate body before integration molding of a solid battery, packaging of a ceramic green body before sintering, or the like.

What is claimed is:

1. A pouch cell, comprising:
a storage discharge element; and
an exterior film that packages the storage discharge element,
wherein the storage discharge element includes a corner part,
the exterior film includes a bend part that is bent to face the corner part, and
a recess groove part that is spaced from the corner part is formed on the bend part at a position that faces the corner part along the corner part.

2. The pouch cell according to claim 1,
wherein the recess groove part includes: an opening-side groove portion in which surfaces that face each other at an opening side close to the corner part are spaced from each other; and a rear-side groove portion in which surfaces that face each other at a rear side spaced from the corner part are in contact with each other.

3. A pouch cell production method which is a production method of a pouch cell that comprises: a storage discharge element having a corner part; and an exterior film that packages the storage discharge element, the method including:
a groove formation process in which a recess groove is formed along the corner part on a bend part that is bent along the corner part in the exterior film; and
a package process in which the bend part is bent along the corner part and the storage discharge element is packaged by the exterior film,
wherein in the package process, by bending the bend part, a recess groove part that is spaced from the corner part is formed at a position that faces the corner part along the corner part by the recess groove.

4. The pouch cell production method according to claim 3,
wherein in the groove formation process, the recess groove is formed to include: an opening-side inclination portion that is inclined by a first angle in a thickness direction of the exterior film; and a rear-side inclination portion that is inclined by a second angle, and
in the package process, by bending the bend part, the groove recess part is formed which includes: by the opening-side inclination portion, an opening-side groove portion in which surfaces that face each other at an opening side close to the corner part are spaced from each other; and by the rear-side inclination portion, a rear-side groove portion in which surfaces that face each other at a rear side spaced from the corner part are in contact with each other.

5. The pouch cell production method according to claim 4,
wherein in the groove formation process, the opening-side inclination portion is formed after forming the rear-side inclination portion on the exterior film.
